(19) United States
(12) Patent Application Publication
(10) Pub. No.: US 2024/0113394 A1
(43) Pub. Date: Apr. 4, 2024

(54) LITHIUM METAL ANODE STRUCTURE, ELECTROCHEMICAL DEVICE COMPRISING SAME, AND METHOD FOR MANUFACTURING LITHIUM METAL ANODE STRUCTURE

(71) Applicant: GRINERGY CO.LTD., Seoul (KR)

(72) Inventor: Jaeik Lim, Seoul (KR)

(21) Appl. No.: 17/768,767

(22) PCT Filed: Oct. 25, 2019
(86) PCT No.: PCT/KR2019/014142

§ 371 Date: Apr. 13, 2022

(51) Int. Cl. H01M 50/46; H01M 4/04; H01M 4/134; H01M 4/1395; H01M 4/38; H01M 50/446; H01M 50/449; H01M 50/491

(52) U.S. Cl. CPC H01M 50/46; H01M 4/0435; H01M 4/134; H01M 4/1395; H01M 4/382; H01M 50/446; H01M 50/449; H01M 50/491; H01M 2004/027

(57) ABSTRACT

A lithium metal anode structure, an electrochemical device including the same, and a method of manufacturing the lithium metal anode structure are disclosed. The lithium metal anode structure includes: a lithium metal anode; and a separator membrane bound to at least one surface of the lithium metal anode, wherein the separator membrane includes a porous substrate and an inorganic layer coated on the porous substrate, the inorganic layer includes inorganic nanoparticles having an average particle diameter of 5 nm to 200 nm, and the inorganic layer is arranged between the lithium metal anode and the porous substrate.

### TECHNICAL FIELD

The present disclosure relates to a lithium metal anode structure, an electrochemical device including the same, and a method of manufacturing the lithium metal anode structure.

### BACKGROUND ART

As electrical and electronic products increasingly become lighter, thinner, shorter, smaller, and more portable, the secondary battery, which is a key component, needs to be made lighter and smaller, and the development of a high-power and energy-density battery is required. In response to these needs, recently, one of the new high-performance, next-generation and cutting-edge batteries receiving the most attention is the lithium metal secondary battery.

Lithium metal anodes are currently attracting attention as key materials of the next generation of batteries. Since a lithium metal anode has a specific capacity more than 10 times greater than that of an anode generally used in lithium-ion secondary batteries, the weight and thickness of the anode can be dramatically reduced, and thus a lithium metal anode is commonly used in the development of a battery having an energy density of 400 Wh/kg or 1,000 Wh/L or more.

A method of manufacturing a lithium metal anode includes preparing a lithium foil having a uniform thickness by extrusion and rolling and may further include binding the prepared lithium foil to a copper foil by pressing before use. Alternatively, lithium may be deposited on another substrate to be made into a thin film form, by using chemical vapor deposition (CVD) or thermal evaporation.

A lithium anode commonly used at present has the form of a rolled foil, which may be exposed to oils and impurities in the process of extrusion, rolling, and pressing, and the lithium foil may have uneven patterns on the surface or be damaged due to excessive rolling performed in order to reduce the thickness of the lithium foil. This leads to uneven surface reactions of the lithium anode, leading to uneven growth of lithium dendrites when the battery is charged/discharged, and increases the possibility of a safety accident due to deterioration of lifespan and occurrence of an internal short circuit.

In order to suppress the growth of lithium dendrites, an inorganic material or a polymer may be coated on the lithium metal anode, or a solid electrolyte may be used; however, due to reactivity and physical properties of lithium metal itself, it is difficult to develop a coating process to coat a lithium metal anode directly, and no coating method except for deposition is actually being applied. In the case of deposition, it is used limitedly for small-scale R&D because of limitations in sample size and difficulties in applying it to a continuous rolling process. In the case of a solid electrolyte, it is difficult to be applied in mass production of batteries due to issues of interface resistance with electrodes and limitations in sample size.

### DESCRIPTION OF EMBODIMENTS

### Technical Problem

An aspect is to provide a lithium metal anode structure that suppresses growth of lithium dendrites and minimizes reaction of lithium in life cycles of a battery by forming a lithium metal anode having a uniform surface.

Another aspect is to provide an electrochemical device that includes the lithium metal anode structure.

Still another aspect is to provide a method of manufacturing the lithium metal anode structure.

### Solution to Problem

According to an aspect, there is provided a lithium metal anode structure including: a lithium metal anode; and a separator membrane bound to at least one surface of the lithium metal anode, wherein the separator membrane includes a porous substrate and an inorganic layer coated on the porous substrate, the inorganic layer includes inorganic nanoparticles having an average particle diameter of 5 nm to 200 nm, and the inorganic layer is arranged between the lithium metal anode and the porous substrate;

According to another aspect, an electrochemical device including the lithium metal anode structure is provided.

According to still another aspect, there is provided a method of manufacturing the lithium metal anode structure including: binding the separator membrane on at least one surface of the lithium metal anode using a roll or a press, wherein the separator membrane includes a porous substrate and an inorganic layer coated on the porous substrate and the inorganic layer includes inorganic nanoparticles having an average particle diameter of 5 nm to 200 nm; and arranging the inorganic layer between the lithium metal anode and the porous substrate.

### ADVANTAGEOUS EFFECTS OF DISCLOSURE

A lithium metal anode structure according to an embodiment has a lithium metal anode having a uniform surface, has an improved sealing between the inorganic layer and the lithium metal anode to suppress growth of lithium dendrites and to minimize reactions of lithium in a life cycle of a battery. Thus, the lithium metal anode structure may be applied to various electrochemical devices including lithium metal secondary batteries to improve lifespan and stability.

### BRIEF DESCRIPTION OF DRAWINGS

FIG. 1 is an example schematic diagram of a lithium metal anode structure according to an embodiment.

FIG. 2 shows a laminated battery structure using a lithium metal anode structure according to an embodiment.

FIG. 3 shows an example of a method of manufacturing a lithium metal anode by using a roll.

FIG. 4A is a photograph of a lithium metal anode of Comparative Example 1.

FIG. 4B is a photograph of a lithium metal anode structure of Example 1.

FIG. 4C is a photograph showing a lithium metal anode having improved surface uniformity in the lithium metal anode structure of Example 1.

FIG. 5 shows a photograph of the surface of the lithium metal anode of Comparative Example 1, and the results of surface roughness analysis conducted by using a Keyence microscope.

FIG. 6 shows a photograph of the surface of the lithium metal anode of the lithium metal anode structure of Example 1, and the results of surface roughness analysis conducted by using a Keyence microscope.

FIG. 7 is a graph showing the results of measurement of discharge capacities per cycle of lithium metal batteries of Comparative Example 2 and Example 2.

FIG. 8 is a graph showing the results of measurement of charge capacity/discharge capacity efficiency per cycle of lithium metal batteries of Comparative Example 2 and Example 2.

FIG. 9 is an example schematic diagram of a lithium metal battery according to an embodiment.

### MODE OF DISCLOSURE

The present inventive concept may be modified in various forms and have many examples, and particular examples are illustrated in the drawings and are described in the detailed description. However, this does not intend to limit the present inventive concept within particular embodiments, and it should be understood that the present disclosure includes all the modifications, equivalents, and replacements within the idea and technical scope of the present inventive concept.

Terms used herein were used to describe particular examples, and not to limit the present inventive concept. As used herein, the singular of any term includes the plural, unless the context otherwise requires. The expression of “include” or “have” used herein indicates the existence of a characteristic, a number, a phase, a movement, an element, a component, a material or a combination thereof, and it should not be construed to exclude in advance the existence or possibility of existence of at least one of other characteristics, numbers, movements, elements, components, materials or combinations thereof. As used herein, “I” may be interpreted to mean “and” or “or” depending on the context.

In the drawings, a diameter, length, or thickness is enlarged or reduced to clearly represent various components, layers and regions. The same reference numerals were attached to similar portions throughout the disclosure. As used herein throughout the disclosure, when a layer, a film, a region, or a plate is described to be “on” or “above” something else, it not only includes the case that it is right above something else but also the case when other portions are present in-between. Terms like “first”, “second”, and the like may be used to describe various components, but the components are not limited by the terms. The terms are used merely for the purpose of distinguishing one component from other components. In the drawings, a part of components may be omitted, but it is not intended to exclude the omitted component(s) but to help understand features of the disclosure.

Hereinafter, an exemplary lithium metal anode structure, an electrochemical device including the same, and a method of manufacturing the lithium metal anode structure will be described in more detail referring to attached drawings.

A lithium metal anode structure according to an embodiment includes:
a lithium metal anode; and
a separator membrane bound to at least one surface of the lithium metal anode, wherein the separator membrane includes a porous substrate and an inorganic layer coated on the porous substrate including inorganic nanoparticles of a size of 5 nm to 200 nm, and the inorganic layer is arranged between the lithium metal anode and the porous substrate.

In the lithium metal anode structure, a lithium metal anode, a separator membrane coated by an inorganic layer were all rolled together to be integrated as a whole. Accordingly, unlike lithium metal anode structures of the related art that have uneven surfaces, the lithium metal anode in the lithium metal anode structure has an arithmetic average surface roughness (Ra) less than 1, which indicates that it has a uniform surface. In the case of a currently commercialized lithium metal anode, general roll pressing is used and due to difference in elongation rate between the substrate foil (copper) and the lithium foil, it is difficult to obtain a uniform surface.

The lithium metal anode structure has a lithium metal anode having a uniform surface, has an improved sealing between the inorganic layer and the lithium metal anode to suppress growth of lithium dendrites on the surface of the lithium metal anode and to minimize reactions of lithium in a life cycle of a battery. Thus, the lithium metal anode structure may be applied to various electrochemical devices including lithium metal secondary batteries and improve lifespan and stability.

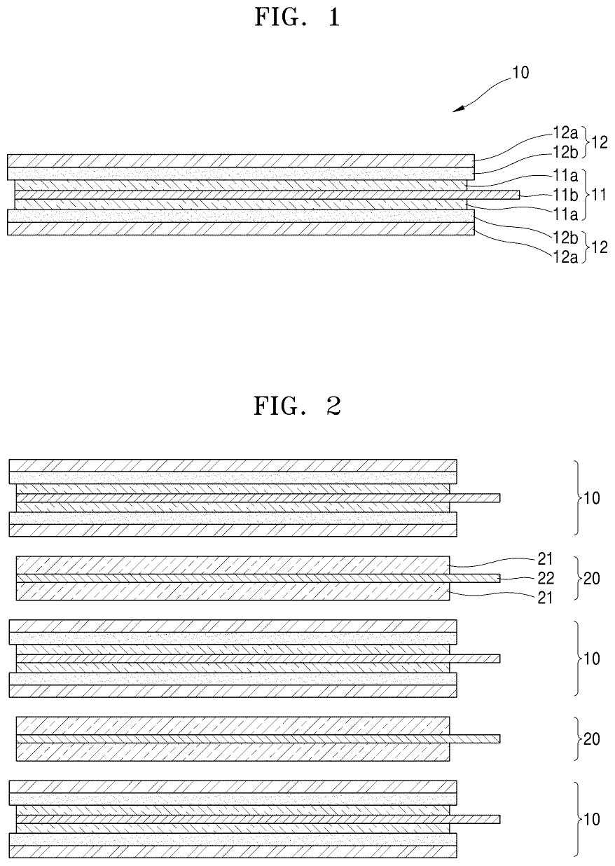

FIG. 1 is an exemplary schematic diagram of a lithium metal anode structure according to an embodiment.

As shown in FIG. 1, the lithium metal anode structure 10 may have a structure that a separator membrane 12 is bound to at least one surface, for example, both surfaces of the lithium metal anode 11, and the separator membrane includes a porous substrate 12a on which an inorganic layer 12b is coated.

The lithium metal anode 11 may have lithium thin films 11a on both surfaces of the current collector 11b such as copper foil pressed by, for example, a roll pressing.

According to an example, the surface roughness (Ra) of the lithium metal anode 11 may be 1 or less, for example, 0.9 or less, for example, 0.8 or less, for example, 0.7 or less, for example, 0.6 or less, For example, 0.5 or less, for example, 0.4 or less, for example, 0.3 or less, for example, 0.2 or less, or for example, 0.1 or less. When the lithium metal anode has a surface roughness within the range, the surface is uniform, uneven growth of lithium dendrites on the surface is suppressed, and safety accidents due to deterioration of lifespan and occurrence of an internal short circuit may be inhibited.

A thickness of the lithium metal anode may be 100 μm or less, for example, 80 μm or less, 50 μm or less, 30 μm or less, or 20 μm or less. According to another embodiment, a thickness of the lithium metal anode may be 0.1 μm to 60 μm. Specifically, a thickness of the lithium metal anode may be 1 μm to 25 μm, for example, 5 μm to 20 μm.

The separator membrane includes an inorganic layer including a porous substrate and inorganic nanoparticles of a size of 5 nm to 200 nm coated on the porous substrate.

In the separator membrane, the porous substrate may be a porous film including polyolefin. Polyolefin has an excellent short circuit prevention effect and may also improve the stability of the battery by a shutdown effect. For example, the porous substrate may be a film consisting of resin of at least one copolymer selected from polyethylene, polypropylene, polybutylene, polypentene, polyhexene, polyoctene, ethylene, propylene, butene, pentene, 4-methylpentene, hexene and octene, or a mixture or combination thereof, but is not necessarily limited thereto, but any porous film that can be used in the art may be used. For example, a porous film consisting of a polyolefin-based resin; a porous film made by weaving polyolefin-based fibers; a non-woven fabric including polyolefin; and an aggregate of insulating material particles may be used. For example, the porous film including polyolefin has excellent coating properties for a binder solution which is used to prepare a coating layer formed on the substrate, and a film thickness of the separation membrane may be reduced to increase the proportion of active materials in the battery and to increase the capacity per unit volume.

A thickness of the porous substrate may be 1 μm to 50 μm. For example, a thickness of the porous substrate may be 1 μm to 30 μm. For example, a thickness of the porous substrate may be 3 μm to 20 μm. For example, a thickness of the porous substrate may be 3 μm to 15 μm. For example, a thickness of the porous substrate may be 3 μm to 12 μm. When a thickness of the porous substrate is less than 1 μm, it may be difficult to maintain the mechanical properties of the separator membrane, and when a thickness of the porous substrate is more than 50 μm, internal resistance of the lithium battery may be increased and energy density of the lithium metal battery may also be lost.

The inorganic layer includes inorganic nanoparticles of a size of 5 nm to 200 nm.

According to an example, the inorganic nanoparticles may include a ceramic material. The ceramic material may include at least one selected from, for example, alumina (Al₂O₃), silica (SiO₂), zinc oxide, zirconium oxide (ZrO₂), zeolite, titanium oxide (TiO₂), barium titanate (BaTiO₃), strontium titanate (SrTiO₃), calcium titanate (CaTiO₃), aluminum borate, iron oxide, calcium carbonate, barium carbonate, lead oxide, tin oxide, cerium oxide, calcium oxide, trimanganese tetraoxide, magnesium oxide, niobium oxide, tantalum pentoxide, tungsten oxide, antimony oxide, aluminum phosphate, calcium silicate, zirconium silicate, indium tin oxide (ITO), titanium silicate, montmorillonite, saponite, vermiculite, hydrotalcite. kaolinite, kanemite, magadiite, and kenyaite, but is not limited thereto.

According to another example, the inorganic nanoparticles may include a solid electrolyte material. The solid electrolyte material may include at least one inorganic lithium ion conductor selected from oxide-based, phosphate-based, sulfide-based, and lithium phosphorous oxy-nitride (LiPON)-based inorganic materials having lithium ion conductivity.

The inorganic lithium ion conductor may be at least one selected from the group consisting of, for example, a garnet compound, an argyrodite compound, a lithium super-ion-conductor (LISICON) compound, a Na super ionic conductor-like (NASICON) compound, lithium nitride, lithium hydride, perovskite, lithium halide, and a sulfide-based compound.

The inorganic lithium ion conductor may include, for example, at least one selected from the group consisting of garnet-based ceramics Li₃₊ₓLa₃M₂O₁₂(0≤x≤5 and M is at least one selected from W, Ta, Te, Nb, and Zr), doped garnet-based ceramics Li₇₋₃ₓM′ₓLa₃M₂O₁₂ (0<x≤1, M is at least one selected from W, Ta, Te, Nb, and Zr, and M′ is at least one selected from Al, Ga, Nb, Ta, Fe, Zn, Y, Sm, and Gd), (0<x<2 and 0≤y<3), BaTiO₃, Pb(Zr,Ti)O₃ (PZT), Pb₁₋ₓLaₓZr_{1-y}Ti_{y}O₃ (PLZT) (0≤x<1 and 0≤y<1), Pb(Mg_{1/3}Nb_{2/3})O₃—PbTiO₃ (PMN-PT), lithium phosphate (Li₃PO₄), lithium titanium phosphate (LiₓTi_{y}(PO₄)₃, 0<x<2 and 0<y<3), lithium aluminum titanium phosphate (LiₓAl_{y}Ti_{z}(PO₄)₃, 0<x<2, 0<y<1, and 0<z<3), Li_{1+x+y}(Al, Ga)ₓ(Ti, Ge)₂₋ₓSi_{y}P_{3-y}O₁₂(O≤x≤1 and 0<y<1), lithium lanthanum titanate (LiₓLa_{y}TiO₃, 0<x<2 and 0<y<3), lithium germanium thiophosphate (LiₓGe_{y}PzSw, 0<x<4, 0<y<1, 0<z<1 and 0<w<5), lithium nitride (LiₓN_{y}, 0<x<4, and 0<y<2), SiS₂-based glass (LiₓSi_{y}S_{z}, 0<x<3, 0<y<2, and 0<z<4), P₂S₅-based glass (LiₓP_{y}S_{z}, 0<x<3, 0<y<3, and 0<z<7), Li₃ₓLa_{2/3-x}TiO₃ (0≤x≤⅙), Li₇La₃Zr₂O₁₂, Li_{1+y}Al_{y}Ti_{2-y}(PO₄)₃ (0≤y≤1), Li_{1+z}Al_{z}Ge_{2-z}(PO₄)₃ (0≤z≤1), Li₂O, LiF, LiOH, Li₂CO₃, LiAlO₂, Li₂O—Al₂O₃—SiO₂—P₂O₅—TiO₂—GeO₂-based ceramics, Li₁₀GeP₂S₁₂, Li_{3.25}Ge_{0.25}P_{0.75}S₄, Li₃PS₄, Li₆PS₅Br, Li₆PS₅Cl, Li₇PS₅, Li₆PS₅I, Li_{1.3} Al_{0.3}Ti_{1.7}(PO₄)₃, LiTi₂(PO₄)₃, LiGe₂(PO₄)₃, LiHf₂(PO₄)₃, LiZr₂(PO₄)₃, Li₂NH₂, Li₃(NH₂)₂I, LiBH₄, LiAlH₄, LiNH₂, Li_{0.34}La_{0.51}TiO_{2.94}, LiSr₂Ti₂NbO₉, Li_{0.06}La_{0.66}Ti_{0.93}Al_{0.03}O₃, Li_{0.34}Nd_{0.55}TiO₃, Li₂CdCl₄, Li₂MgCl₄, Li₂ZnI₄, Li₂CdI₄, Li_{4.9}Ga_{0.5+δ}La₃Zr_{1.7}Al_{0.3}O₁₂ (0≤δ<1.6), Li_{4.9}Ga_{0.5+δ}La₃Zr_{1.7}W_{0.3}O₁₂ (1.7≤δ≤2.5), Li_{5.39}Ga_{0.5+δ}La₃Zr_{1.7}W_{0.3}O₁₂(0≤δ≤1.11), lithium phosphorus sulfide (LPS) (Li₃PS₄), lithium tin sulfide (LTS) (Li₄SnS₄), lithium phosphorus sulfur chloride iodide (LPSCLL) (Li₆PS₅Cl_{0.9}I_{0.1}), lithium tin phosphorus sulfide (LSPS) (Li₁₀SnP₂S₁₂), Li₂S, Li₂S—P₂S₅, Li₂S—SiS₂, Li₂S—GeS₂, Li₂S—B₂S₅, and Li₂S—Al₂S₅.

For example, as the inorganic lithium ion conductor, garnet lithium lanthanum zirconium oxide (LLZO), aluminum-doped lithium lanthanum zirconium oxide (Li₇₋₃ₓAlₓLa₃Zr₂O₁₂) (0<x≤1) may be used, as a pseudo-oxide solid electrolyte, lithium lanthanum titanate (LLTO) (Li_{0.34}La_{0.51}TiOy) (0<y≤3), lithium aluminum titanium phosphate (LATP) (Li_{1.3}Al_{0.3}Ti_{1.7}(PO₄)₃), and the like may be used, and as a sulfur compound, lithium phosphorus sulfide (LPS) (Li₃PS₄), lithium tin sulfide (LTS) (Li₄SnS₄), lithium phosphorus sulfur chloride iodide (LPSCLL) (Li₆PS₅Cl_{0.9}I_{0.1}), lithium tin phosphorus sulfide (LSPS) (Li₁₀SnP₂S₁₂), and the like may be used.

The inorganic nanoparticles may have a particle or columnar structure, or other irregular forms.

A size of the inorganic nanoparticles may be 5 nm to 200 nm, for example, 10 nm to 150 nm, for example, 20 nm to 100 nm, for example, 10 nm to 100 nm. When the average particle diameter of the inorganic nanoparticles are within the range, surface uniformity of the lithium metal anode may be improved through a rolling process. As used herein, “size of inorganic nanoparticles” refer to the average particle diameter when the inorganic nanoparticles are spherical, and the length of the long axis when the inorganic nanoparticles are non-spherical. A size of the inorganic nanoparticles can be measured using a particle size measuring instrument or by using an electron scanning microscope, and the like.

An amount of the inorganic nanoparticles may be at least 10 wt % or more, 15 wt % or more, 20 wt % or more, 30 wt % or more, 40 wt % or more, 50 wt % or more, or 90 wt % or more, with respect to a total weight of the coating layer. For example, an amount of the inorganic nanoparticles may be in the range of 70 wt % to 98 wt %, with respect to a total weight of the coating layer. When an amount of the inorganic nanoparticles is within the range, surface uniformity of the lithium metal anode and sealing of the surface of the lithium metal anode may be improved.

The inorganic layer may further include an organic binder. In this case, the inorganic layer may have a form in which inorganic nanoparticles are dispersed in the matrix consisting of the organic binder.

The organic binder may include, for example, at least one selected from polyvinylidene fluoride, polyvinylidene fluoride-hexafluoropropylene, polyvinylidene chloride, polybenzimidazole, polyimide, polyvinyl acetate, polyacrylonitrile, polyurethane, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenylsulfide, polyamideimide, polyetherimide, polyethylenesulfone, polyamide, polyacetal, polyethylene oxide, polyethylene glycol diacrylate, polyethylene glycol monoacrylate, polyphenylene oxide, polybutylene terephthalate, ethylene propylene diene terpolymer (EPDM), sulfonated EPDM, styrene butadiene rubber, fluororubber, and copolymers thereof.

When the inorganic layer includes inorganic nanoparticles and an organic binder, an amount of the organic binder may be in a range of 50 wt % to 99 wt %, for example, 60 wt % to 98 wt %, 70 wt % to 97 wt %, or 80 wt % to 96 wt %, with respect to a total weight of the inorganic nanoparticles and the organic binder. When an amount of the organic binder is within the range, binding between the inorganic layer and the lithium metal anode may be further improved.

According to an example, a thickness of the inorganic layer may be 0.1 μm to 50 μm, for example, 1 μm to 5 μm, for example, 2 μm to 4 μm. When a thickness of the inorganic layer is within the above range, surface uniformity of the lithium metal anode and sealing between the inorganic layer and the lithium metal anode may be improved in a rolling process of the lithium metal anode and the separator membrane.

According to an example, the separator membrane may further include a polymer coating layer on the inorganic layer. The polymer coating layer may further improve the binding between the inorganic layer and the lithium metal cathode, and growth of lithium dendrites may be further suppressed.

A material used for the polymer coating layer may be, for example, at least one selected from polyvinylidene fluoride, polyvinylidene fluoride-hexafluoropropylene, polyvinylidene chloride, polybenzimidazole, polyimide, polyvinyl acetate, polyacrylonitrile, polyurethane, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenylsulfide, polyamideimide, polyetherimide, polyethylenesulfone, polyamide, polyacetal, polyethylene oxide, polyethylene glycol diacrylate, polyethylene glycol monoacrylate, polyphenylene oxide, polybutylene terephthalate, ethylene propylene diene terpolymer (EPDM), sulfonated EPDM, styrene butadiene rubber, fluororubber, and copolymers thereof.

According to an example, the polymer coating layer may include the same material as the organic binder used in the inorganic layer.

A thickness of the separator membrane may be 14 μm to 20 μm, and permeability may be 180 sec/100 cc, for example, 185 sec/100 cc to 210 sec/100 cc. When permeability is within the range, the pores formed in the separation membrane are sufficiently opened, thereby an excellent ion conductivity is achieved and the battery output and battery performance may be improved.

The lithium metal anode structure improves the sealing between the inorganic layer and the lithium metal anode surface so that porosity between the lithium metal anode and the inorganic layer may be 0% to 10%, for example, 0% to 9%, 0% to 8%, 0% to 7%, 0% to 6%, 0% to 5%, 0% to 4%, 0% to 3%, 0% to 2%, or 0% to 1%. When porosity between the lithium metal anode and the inorganic layer is within the range, growth of lithium dendrites on the surface of the lithium metal anode may be suppressed maximally.

In a lithium metal anode structure according to an embodiment, a separator membrane coated with an inorganic layer may be bound to the surface of a lithium metal anode through a rolling process, thereby improving surface uniformity which is the biggest issue in a lithium metal anode, and by improving the sealing between the inorganic layer and the surface of the lithium metal anode, the reactions may become more uniform and growth of lithium dendrites may be maximally suppressed, thereby the lithium metal anode structure may contribute to improving lifespan properties of the battery and suppressing occurrence of a short circuit and ignition or explosion due to the short circuit.

FIG. 2 shows a laminated battery structure using a lithium metal anode structure according to an embodiment.

As shown in FIG. 2, the lithium metal anode structure 10 and the cathode 20 may be directly laminated to assemble a pouch unicell which may be applied in various batteries. Here, in the cathode 20, a positive electrode active material layer 21 may be arranged on both surfaces of the current collector 22, such as aluminum foil.

Hereinafter, a method of manufacturing a lithium metal anode structure according to an embodiment will be described.

A method of manufacturing a lithium metal anode structure according to an embodiment includes binding a separator membrane on at least one surface of a lithium metal anode using a roll or a press, wherein the separator membrane includes an inorganic layer including a porous substrate and inorganic nanoparticles coated on the porous substrate which have an average particle diameter of 5 nm to 200 nm, and the inorganic layer is arranged between the lithium metal anode and the porous substrate.

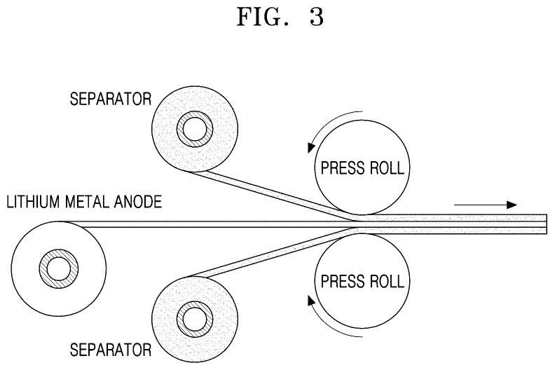

FIG. 3. shows an example of a method of manufacturing the lithium metal anode structure using a roll according to an embodiment.

As shown in FIG. 3, the separator membrane including the porous substrate coated with the inorganic layer is bound to at least one, for example, two surfaces of the lithium metal anode using a rolling process.

The binding may be performed by hot rolling or cold rolling.

A hot rolling is performed, for example, at 30° C. to 90° C., and a cold rolling is performed, for example, at 20° C. to 30° C., and the binding is performed, for example, at a nip pressure of 50 kgf to 1,000 kgf. In the interval in which surface the uniformity is improved, a nip pressure may be in the range of 200 kgf to 500 kgf, and in a case of a hot rolling, even a lower pressure may bring about an improved binding strength.

Since the lithium metal anode structure obtained through such a rolling process can be easily applied to conventional processes for manufacturing batteries, mass-production is possible, and the lithium metal anode structure may also be used for all-solid batteries in the future.

A method of manufacturing the lithium metal anode structure by using a rolling process includes binding the separator membrane coated with the inorganic layer to the surface of the lithium metal anode, thus improving surface uniformity of the lithium metal anode, and improving the sealing between the inorganic layer and the surface of the lithium metal anode. The method may provide a lithium metal anode structure that induces uniform reactions, maximally suppresses growth of lithium dendrites, and enhances the battery lifespan and stability.

An electrochemical device according to an embodiment includes the above-described lithium metal anode structure. The electrochemical device including the lithium metal anode structure suppresses growth of lithium dendrites, and improves lifespan and stability.

The electrochemical device may be a lithium secondary battery such as a lithium-ion battlithium-ion battery, a lithium polymer battery, a lithium metal battery, a lithium air battery, a lithium all-solid battery.

A lithium secondary battery according to an example may include: an anode including the lithium metal anode structure; a cathode arranged opposite the anode; and an electrolyte arranged between the anode and the cathode.

The anode includes the lithium metal anode structure. The lithium metal anode structure may be manufactured by the manufacturing method.

The anode may further include, in addition to the above-described lithium metal anode structure, a negative electrode active material generally used in the art as a negative electrode active material for a lithium battery. A negative electrode active material generally used in the art may include, for example, at least one selected from the group consisting of lithium metal, metal alloyable with lithium, transition metal oxide, non-transition metal oxide, and carbon-based material.

For example, the metal alloyable with lithium may be Si, Sn, Al, Ge, Pb, Bi, Sb, Si—Y alloy (wherein Y is an alkali metal, an alkaline earth metal, a group 13 element, a group 14 element, a transition metal, a rare earth element, or a combination thereof, and not Si), Sn—Y alloy (wherein Y is an alkali metal, an alkaline earth metal, an element from group 13 to 16, a transition metal, a rare earth element, or a combination thereof, and not Sn), or the like. The element Y may be Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, or a combination thereof.

For example, the transition metal oxide may be lithium titanium oxide, vanadium oxide, lithium vanadium oxide, or the like.

For example, the non-transition oxide may be SnO₂, SiOₓ(0<x≤2), and the like.

The carbon-based material may be crystalline carbon, amorphous carbon, or a mixture thereof. The crystalline carbon may be amorphous, plate-like, flake-like, spherical or graphite, such as natural fibrous graphite or artificial graphite, and the amorphous carbon may be soft carbon (low temperature calcined carbon) or hard carbon, mesophase pitch carbide, calcined coke, or the like.

When the negative electrode active material and the carbon-based material are used together, oxidation reaction of the silicon-based active material is suppressed, and solid electrolyte interface (SEI) film is effectively formed to form a stable film and to improve electrical conductivity, and thus charge/discharge characteristics of lithium may be further improved.

A negative electrode active material generally used in the art may be coated on the surface of the lithium metal anode structure, or be used in any combined form. For example, a negative electrode active material and a binder with or without a conductive material may be mixed in a solvent to prepare a negative electrode active material composition, then the negative electrode active material composition may be prepared to combine with the lithium metal anode structure by being molded into a certain form, coated on the lithium metal anode structure, or coated on a current collector such as copper foil.

The binder used in the negative electrode active material composition is an ingredient which helps the negative electrode active material to bind to the conductive material, and the like, and to the current collector, and an amount added is 1 part by weight to 50 parts by weight with respect to 100 parts by weight of the negative electrode active material. For example, the binder may be added in an amount of 1 part by weight to 30 parts by weight, 1 part by weight to 20 parts by weight, or 1 part by weight to 15 parts by weight, with respect to 100 parts by weight of the negative electrode active material. Examples of the binder are, polyvinylidene fluoride, polyvinylidene chloride, polybenzimidazole, polyimide, polyvinyl acetate, polyacrylonitrile, polyvinyl alcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrile butadiene styrene, phenol resin, epoxy resin, polyethylene terephthalate, polytetrafluoroethylene, polyphenyl sulfide, polyamideimide, polyetherimide, polyethylene sulfone, polyimide, polyacetal, polyphenylene oxide, polybutylene terephthalate, ethylene-propylene-diene terpolymer (EPDM), sulfonated EPDM, styrene butadiene rubber, fluororubber, and various coploymers thereof.

The anode may optionally further include a conductive material to provide a conductive passage to the negative electrode active material to further improve electrical conductivity. For the conductive material, any generally used conductive material for a lithium battery may be used, and examples include carbon-based materials such as carbon black, acetylene black, ketjen black, carbon fibers (for example, vapor grown carbon fibers); metal-based materials such as metal powder or metal fibers of copper, nickel, aluminum, silver, and et al.; conductive polymers such as polyphenylene derivatives, or a mixture thereof. An amount of the conductive material may be appropriately adjusted before use. For example, the weight ratio of the negative electrode active material and conductive material added may be 99:1 to 90:10.

As the solvent, N-methylpyrrolidone (NMP), acetone, water and the like may be used. An amount of the solvent used is 1 part by weight to 10 parts by weight with respect to 100 parts by weight of the negative electrode active material. When an amount of the solvent is within the range, an active material layer is easily formed.

In addition, the current collector is generally made to have a thickness of 3 μm to 500 μm. For the current collector, any that does not cause a chemical change in the battery and has conductivity may be used, for example, copper, stainless steel, aluminum, nickel, titanium, plastic carbon, and copper or stainless steel coated with carbon, nickel, titanium, silver, and the like on the surface, aluminum-cadmium alloys, and the like may be used. Further, binding strength of the current collector with the negative electrode active material may be enhanced by forming fine irregularities on the surface of the current collector and the current collector may be used in various forms such as films, sheets, foils, nets, porous materials, foams, or nonwoven fabrics.

The negative electrode plate may be prepared by coating the prepared negative electrode active material composition directly on the lithium metal anode structure, or on the current collector, or by casting the negative electrode active material composition onto a separate support, and then laminating the negative electrode active material film peeled off from the support on a copper foil current collector. The anode is not limited to the above-described forms, but may have a form other than the above-described forms.

The negative electrode active material composition is not only used for manufacturing an electrode of a lithium secondary battery, but also may be printed on a flexible electrode and used for manufacturing a printable battery.

Separately, in order to prepare a cathode, a positive electrode active material composition is prepared, wherein a positive electrode active material, a conductive material, a binder, and a solvent are mixed.

As the positive electrode active material, any lithium-containing metal oxide may be used without limitation as long as it is generally used in the art.

For example, a compound represented by any of the following formulas may be used: LiₐA_{1-b}B_{b}D₂ (wherein 0.90≤a≤1.8, and 0≤b≤0.5); LiₐE_{1-b}BbO_{2-c}D_{c} (wherein 0.90≤a≤1.8, 0≤b≤0.5, and 0≤c≤0.05); LiE_{2-b}B_{b}O_{4-c}D_{c} (wherein 0≤b≤0.5 and 0≤c≤0.05); LiₐNi_{1-b-c}Co_{b}B_{c}Dₐ (wherein 0.90≤a≤1.8, 0≤b≤0.5, 0≤c≤0.05, and 0≤a≤2); LiₐNi_{1-b-c}Co_{b}B_{c}O₂₋ₐFₐ (wherein 0.90≤a≤1.8, 0≤b≤0.5, 0≤c≤0.05, and 0<a<2); LiₐNi_{1-b-c}Co_{b}B_{c}O₂₋ₐFₐ (wherein 0.90≤a≤1.8, 0≤b≤0.5, 0≤c≤0.05, and 0<a<2); LiₐNi_{1-b-c}Mn_{b}B_{c}Dₐ (wherein 0.90≤a≤1.8, 0≤b≤0.5, 0≤c≤0.05, and 0<a≤2); LiₐNi_{1-b-c}Mn_{b}B_{c}O₂₋ₐFₐ (wherein 0.90≤a≤1.8, 0≤b≤0.5, 0≤c≤0.05, and 0<a<2); LiₐNi_{1-b-c}Mn_{b}B_{c}O₂₋ₐFₐ (wherein 0.90≤a≤1.8, 0≤b≤0.5, 0≤c≤0.05, and 0<a<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8, and 0.001≤b≤0.1); LiₐCoG_{b}O₂ (wherein 0.90≤a≤1.8, and 0.001≤b≤0.1); LiₐMnG_{b}O₂ (wherein 0.90≤a≤1.8, and 0.001≤b≤0.1); LiₐMn₂G_{b}O₄ (wherein 0.90≤a≤1.8, and 0.001≤b≤0.1); QO₂; QS₂; LiQS₂; V₂O₅; LiV₂O₅; LiIO₂; LiNiVO₄; Li_{(3-f)}Fe₂(PO₄)₃(0≤f≤2); Li_{(3-f)}Fe₂(PO₄)₃ (0≤f≤2); and LiFePO₄.

In formulas above, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

As the positive electrode active material, for example, one or more selected from the following may be used: lithium cobalt oxide of the formula LiCoO₂; lithium nickel oxide of the formula LiNiO₂; lithium manganese oxide of the formula Li₁₊ₓMn₂₋ₓO₄ (wherein x is 0 to 0.33), LiMnO₃, LiMn₂O₃, or LiMnO₂; lithium copper oxide of the formula Li₂CuO₂; lithium iron oxide of the formula LiFe₃O₄; lithium vanadium oxide of the formula LiV₃O₈; copper vanadium oxide of the formula Cu₂V₂O₇; vanadium oxide of the formula V₂O₅; lithium nickel oxide of the formula LiNi₁₋ₓMₓO₂ (wherein M is Co, Mn, Al, Cu, Fe, Mg, B or Ga and x is 0.01 to 0.3); lithium manganese composite oxide represented by LiMn₂₋ₓMₓO₂ (wherein M is Co, Ni, Fe, Cr, Zn or Ta, and x is 0.01 to 0.1) or Li₂Mn₃MO₈ (wherein M is Fe, Co, Ni, Cu or Zn); lithium manganese oxide wherein a part of Li of the formula LiMn₂O₄ is substituted with an alkaline earth metal ion; disulfide compounds; iron molybdenum oxide of the formula Fe₂(MoO₄)₃.

Also, the compound with a coating layer on the surface may be used, or a mixture of the compounds with and without a coating layer may be used. The coating layer may include coating element compounds, such as oxide of a coating element, hydroxide of a coating element, oxyhydroxide of a coating element, oxycarbonate of a coating element, or hydroxycarbonate of a coating element. The compounds constituting the coating layer may be amorphous or crystalline. As the coating element included in the coating layer, Mg, Al, Co, K, Na, Ca, Si, Ti, V, Sn, Ge, Ga, B, As, Zr, or a mixture thereof may be used. In the process of forming the coating layer, any coating method coating these elements on the compound may be used as long as it does not adversely affect the physical properties of the positive electrode active material (for example, spray coating, dipping or the like). The coating methods are well understood by those skilled in the art, and a detailed description thereof will be omitted.

For example, LiNiO₂, LiCoO₂, LiMnₓO₂ₓ (x=1, 2), LiNi₁₋ₓMnₓO₂ (0<x<1), LiNi_{1-x-y}CoₓMn_{y}O₂ (0≤x≤0.5, and 0≤y≤0.5), LiFeO₂, V₂O₅, TiS, MoS, and the like may be used.

In the positive electrode active material composition, the conductive material, the binder, and the solvent may be the same as those in the anode active material composition. In some cases, it is also possible to form pores inside the electrode plate by adding a plasticizer to the positive electrode active material composition and the negative electrode active material composition. The content of the positive electrode active material, the content of the conductive material, the content of the binder, and the content of the solvent are levels commonly used in the lithium secondary battery.

The positive electrode current collector is not particularly limited as long as it has a thickness of 3 μm to 500 μm, and has high conductivity without causing a chemical change in the battery, and for example, stainless steel, aluminum, nickel, titanium, plastic carbon, or alternatively, aluminum or stainless steel treated with carbon, nickel, titanium, silver, or the like on the surface, may be used. Forming fine irregularities on the surface of the current collector may enhance the binding strength with the negative electrode active material, and the current collector may be used in various forms such as films, sheets, foils, nets, porous materials, foams, or nonwoven fabrics.

The prepared positive electrode active material composition may be coated directly on the positive electrode current collector and dried to prepare a positive electrode plate. Alternatively, the positive electrode plate may be prepared by casting the positive electrode active material composition onto a separate support, and then laminating the film peeled off from the support on a positive electrode current collector.

The cathode and the anode may be separated by a separator membrane, and for the separator membrane, any commonly used in lithium battery may be used. Especially, a separator membrane having low resistance to the movement of ions and superior in electrolyte wettability is appropriate. For example, the separator membrane may consist of any one selected from glass fiber, polyester, teflon, polyethylene, polypropylene, polytetrafluoroethylene (PTFE), and combinations thereof, and it may be made in a form of a nonwoven fabric or a woven fabric. For the separator membrane, a separator membrane having a pore diameter of 0.01 μm to 10 μm and a thickness of 5 μm to 300 μm may be used.

A lithium salt-containing non-aqueous electrolyte consists of a non-aqueous electrolyte and lithium. As the non-aqueous electrolyte, a non-aqueous electrolyte, a solid electrolyte, and an inorganic solid electrolyte are used.

As the non-aqueous electrolyte, for example, aprotic organic solvents such as N-methyl-2-pyrrolidinone, propylene carbonate, ethylene carbonate, butylene carbonate, dimethyl carbonate, diethyl carbonate, gamma-butylolactone, 1,2-dimethoxy ethane, tetrahydrofuran, 2-methyl tetrahydrofuran, dimethyl sulfoxide, 1,3-dioxolane, formamide, dimethylformamide, acetonitrile, nitromethane, methyl formate, methyl acetate, phosphoric acid triester, trimethoxymethane, dioxolane derivative, sulfolane, methyl sulfolane, 1,3-dimethyl-2-imidazolidinone, propylene carbonate derivatives, tetrahydrofuran derivatives, ethers, methyl pyropionate, and ethyl propionate may be used.

As the organic solid electrolyte, for example, polyethylene derivatives, polyethylene oxide derivatives, polypropylene oxide derivatives, phosphoric acid ester polymers, poly agitation lysine, polyester sulfide, polyvinyl alcohols, polyvinylidene fluoride, polymers including an ionic dissociation group, or the like may be used.

As the inorganic solid electrolyte, for example, nitride, halide, sulfate of Li such as, Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂ and the like may be used.

As the lithium salt, all commonly used in lithium batteries may be used, and a material easily dissolved in the non-aqueous electrolyte, for example, at least one selected from LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, F₂LiNO₄S₂, lithium chloroborate, lithium lower aliphatic carboxylic acid, lithium 4-phenyl borate, imide, etc., may be used.

Lithium secondary batteries may be classified as lithium-ion battlithium-ion batteries, lithium ion polymer batteries and lithium polymer batteries, according to the type of the separator membrane and the electrolyte, may be classified as a cylindrical type, rectangular type, coin type, pouch type, etc., according to the shape, and may be classified as a bulk type and a thin film type according to the size.

The manufacturing method of these batteries is widely known in the art, so a detailed description will be omitted.

The electrochemical device may be a lithium metal battery.

A lithium metal battery may be prepared in a stack type in which a cathode and a lithium metal anode structure are laminated, or alternatively, instead of a stack type, a lithium metal battery may be prepared in a jelly-roll type by winding the cathode and the lithium metal anode structure in a roll shape.

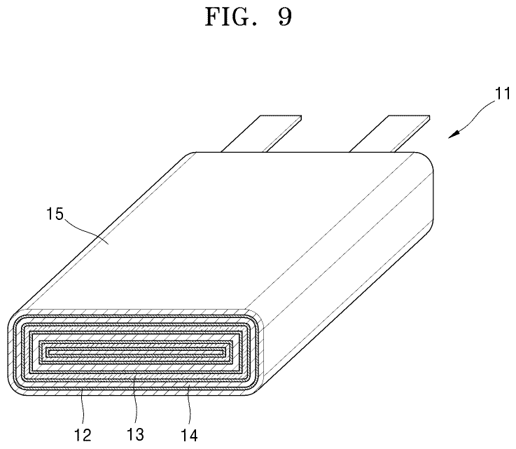

FIG. 9 schematically shows a lithium metal battery structure according to an embodiment.

As shown in FIG. 9, a lithium metal battery 11 includes a cathode 13, an anode 12 including a lithium metal anode structure, and a separator membrane 14. The cathode 13, the anode 12 and the separator membrane 14 are wound or folded and accommodated in a battery case 15. Subsequently, an electrolyte is injected into the battery case 55 and the battery is sealed by a cap assembly 16, and the lithium metal battery (11) is completed. The battery case may have a cylindrical shape, a rectangular shape, or a thin film shape. For example, the lithium secondary battery may be a large thin-film battery. The lithium metal battery may be a lithium-ion battery.

The lithium metal battery has an excellent capacity and lifespan characteristics so it may not only be used in a battery cell used as a power source of small devices, but also may be used as a unit battery in a medium-to-large sized battery pack including a plurality of battery cells, or in a battery module to be used as power sources of medium-to-large sized devices. As examples of the medium-to-large sized device, electric vehicle (EV), hybrid electric vehicle (EV), plug-in hybrid electric vehicle (PHEV), and the like are included.

Example embodiments will be described in more detail through the following examples and comparative examples. However, these examples are provided to illustrate the present disclosure, and the scope of the present disclosure is not limited thereto.

### Example 1: Manufacture of Lithium Metal Anode Structure

First, a composition was obtained by mixing alumina nanoparticles of an average particle diameter of 30 nm and acetonitrile (ACN) solution containing 6 wt % of polyacrylonitrile (PAN) as a binder so that a weight ratio of alumina nanoparticles and PAN was 94:6, and the obtained composition was coated onto a polyethylene substrate, which was vacuum dried at 70° C. for 12 hours to prepare a separation membrane having an inorganic layer formed on a surface of the polyethylene substrate.

On both surfaces of rolled lithium thin film manufactured by Honjo (Japan) (thickness 20 μm), inorganic layers of the separator membrane were arranged to be in contact with the lithium thin film, and through a rolling process as shown in FIG. 3, the separator membrane was bound to the surface of the lithium thin film to prepare a lithium metal anode structure. At this time, hot rolling was carried out at a temperature of 55° C., and a nip pressure of 250 kgf.

### Comparative Example 1: Conventional Lithium Metal Anode

Rolled lithium thin film manufactured by Honjo (Japan) (thickness 20 μm) was chosen as Comparative Example 1.

### Evaluation Example 1: Surface Observation and Surface Roughness Measurement of Lithium Metal Anode

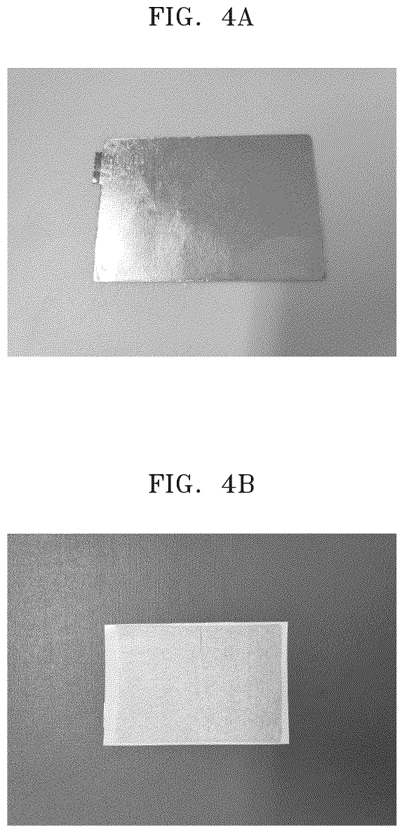

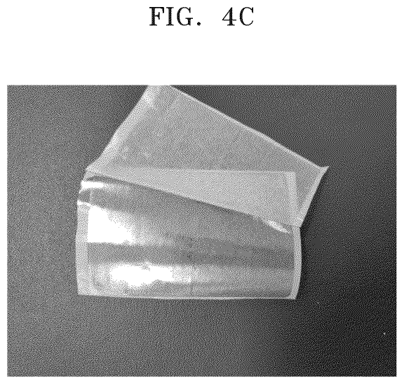

FIG. 4A is a photograph of a lithium metal anode of Comparative Example 1, FIG. 4B is a photograph of the lithium metal anode structure of Example 1, and FIG. 4C is the photograph showing a lithium metal anode with improved surface uniformity in the lithium metal anode structure of Example 1.

As shown in FIGS. 4A to 4C, it was visually noticeable that the surface (FIG. 4C) of the lithium metal anode bound to a separator membrane coated with an inorganic layer was smoother than the surface (FIG. 4A) of a conventional lithium metal anode.

More specifically, in order to find the surface roughness of those lithium metal anodes, using Keyence microscope, surface observation and measurement of surface roughness (Ra) were conducted for the lithium metal anode of Comparative Example 1 and the lithium metal anode structure of Example 1.

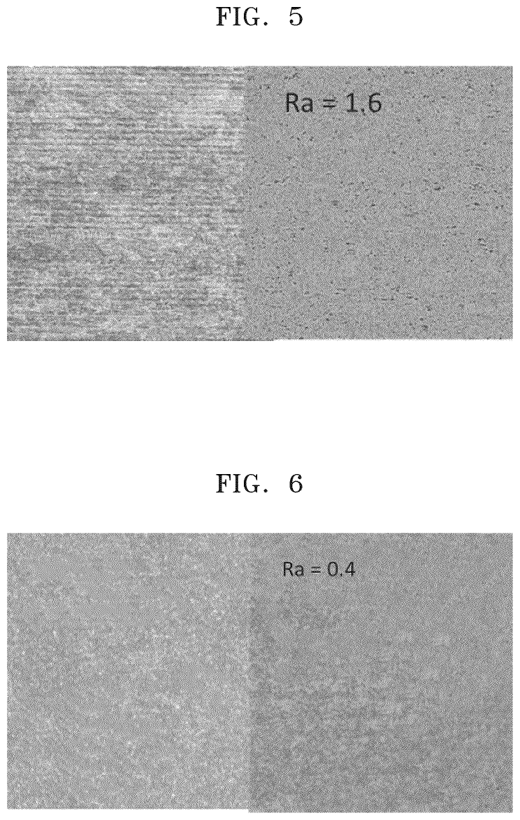

As shown in FIGS. 5 and 6, a conventional lithium metal anode of Comparative Example 1 had a surface roughness (Ra) value of 1.6, but the lithium metal anode structure of Example 1 had a significantly reduced surface roughness (Ra) value of 0.4 after an inorganic layer was bound through a rolling process, and surface uniformity was found to have improved by mapping and by using an optical microscope.

### Example 2: Manufacture of Lithium Metal Battery

The lithium metal anode structure according to Example 1 was used as an anode, and after the cathode was sequentially laminated, the product was put into an aluminum pouch and vacuum sealed to prepare a lithium metal battery.

Here, the cathode was prepared as follows and had been fully impregnated in advance in a DME (1,2-dimethoxyethane) electrolyte solution, wherein 3.5 M of LiFSI (Lithium bis(fluorosulfonyl)imide) was dissolved. In order to prepare a cathode, a conductive material LiNiMnCoO₂ (Super-P; TimCal Ltd.), polyvinylidene fluoride (PVdF) and N-pyrrolidone were mixed to obtain a positive electrode composition. In the positive electrode composition, the weight ratio for mixing LiNiMnCoO₂, the conductive material, and PVdF was 96:2:2. The positive electrode composition was coated on top of an aluminum foil (thickness: about 12 μm), and the coated plate was dried at 110° C. to prepare a cathode.

### Comparative Example 2: Manufacture of Lithium Metal Battery

The same procedures as in Example 2 were performed to prepare a lithium metal battery, except that the lithium metal anode according to Comparative Example 1 was used as an anode.

### Evaluation Example 2: Evaluation of Charge/Discharge Characteristics and Lifespan

For the lithium metal battery according to Example 2 and Comparative Example 2, two formation cycles at 0.05 C-rate were performed, and then 200 cycles of constant current-constant voltage (CC-CV) charge/discharge were carried out at 0.5 C-rate.

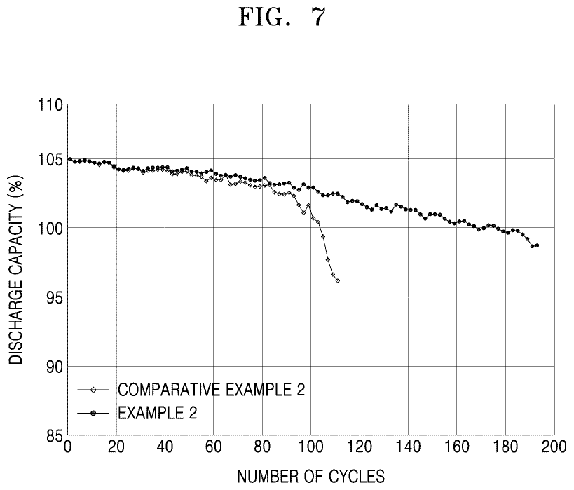

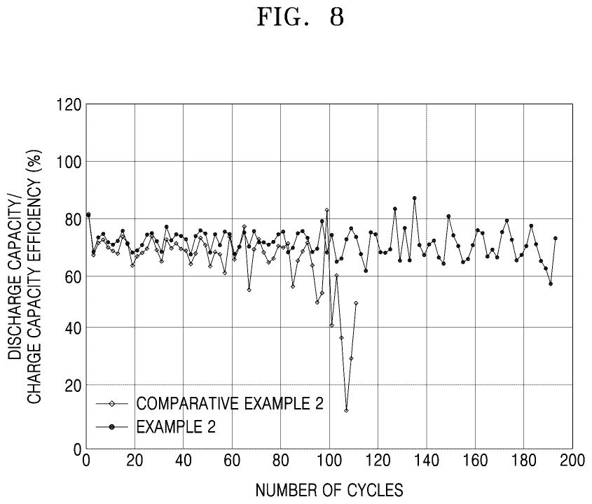

The results of measurement of discharge capacity per cycle of the lithium metal batteries according to Example 2 and Comparative Example 2 are shown in FIG. 7. Further, the results of measurement of discharge capacity/charge capacity efficiency per cycle, that is, Coulomb efficiency of the lithium metal batteries according to Example 2 and Comparative Example 2 are shown in FIG. 8. Here, discharge capacity/charge capacity efficiency is calculated from Formula 1.

Coulomb efficiency [%]=[discharge capacity in each cycle/charge capacity in each cycle]×100 <Formula 1>

As shown in FIGS. 7 and 8, the lithium metal battery of Example 2 has an improved discharge capacity per cycle and lifespan properties compared to the lithium metal battery of Comparative Example 2. Further, it was confirmed that the internal short circuit phenomenon was remarkably inhibited near the end of the lifespan.

So far, preferred embodiments according to the present disclosure have been described with reference to the drawings and examples, but they are only given as examples, and it will be understood by those having an average level of knowledge in the related art that a variety of modifications and equivalent other embodiments are possible. Accordingly, the scope of the present disclosure should be determined by the appended claims.

1. A lithium metal anode structure, comprising:
a lithium metal anode; and
a separator membrane bound to at least one surface of the lithium metal anode, wherein the separator membrane includes a porous substrate and an inorganic layer coated on the porous substrate, the inorganic layer includes inorganic nanoparticles having an average particle diameter of 5 nm to 200 nm and the inorganic layer is arranged between the lithium metal anode and the porous substrate.

2. The lithium metal anode structure of claim 1, wherein the lithium metal anode structure is in a rolled form obtained by a rolling process.

3. The lithium metal anode structure of claim 1, wherein a surface roughness (Ra) of the lithium metal anode is 1 or less.

4. The lithium metal anode structure of claim 1, wherein porosity between the lithium metal anode and the inorganic layer is 0% to 10%.

5. The lithium metal anode structure of claim 1, wherein an average particle diameter of the inorganic nanoparticles is 5 nm to 200 nm.

6. The lithium metal anode structure of claim 1, wherein the inorganic nanoparticles include ceramic material.

7. The lithium metal anode structure of claim 6, wherein the ceramic material includes at least one selected from alumina (Al₂O₃), silica (SiO₂), zinc oxide, zirconium oxide (ZrO₂), zeolite, titanium oxide (TiO₂), barium titanate (BaTiO₃), strontium titanate (SrTiO₃), calcium titanate (CaTiO₃), aluminum borate, iron oxide, calcium carbonate, barium carbonate, lead oxide, tin oxide, cerium oxide, calcium oxide, trimanganese tetraoxide, magnesium oxide, niobium oxide, tantalum pentoxide, tungsten oxide, antimony oxide, aluminum phosphate, calcium silicate, zirconium silicate, indium tin oxide (ITO), titanium silicate, montmorillonite, saponite, vermiculite, hydrotalcite, kaolinite, kanemite, magadiite, and kenyaite.

8. The lithium metal anode structure of claim 1, wherein the inorganic nanoparticles include a solid electrolyte material.

9. The lithium metal anode structure of claim 8, wherein the solid electrolyte material includes at least one inorganic lithium ion conductor selected from the group consisting of a garnet compound, an argyrodite compound, a lithium super-ion-conductor (LISICON) compound, a Na super ionic conductor-like (NASICON) compound, lithium nitride, lithium hydride, perovskite, lithium halide, and a sulfide compound.

10. The lithium metal anode structure of claim 9, wherein the inorganic lithium ion conductor is at least one selected from the group consisting of garnet-based ceramics Li₃₊ₓLa₃M₂O₁₂ (0≤x≤5 and M is at least one selected from W, Ta, Te, Nb, and Zr), doped garnet-based ceramics Li₇₋₃ₓM′ₓLa₃M₂O₁₂ (0<x≤1, M is at least one selected from W, Ta, Te, Nb, and Zr, and M′ is at least one selected from Al, Ga, Nb, Ta, Fe, Zn, Y, Sm, and Gd), Li_{1+x+y}AlₓTi₂₋ₓSi_{y}P_{3-y}O₁₂ (0<x<2 and 0≤y<3), BaTiO₃, Pb(Zr,Ti)O₃ (PZT), Pb₁₋ₓLaₓZr_{1-y}Ti_{y}O₃ (PLZT) (0≤x<1 and 0≤y<1), Pb(Mg_{1/3}Nb_{2/3})O₃—PbTiO₃ (PMN-PT), lithium phosphate (Li₃PO₄), lithium titanium phosphate (LiₓTi_{y}(PO₄)₃, 0<x<2 and 0<y<3), lithium aluminum titanium phosphate (LiₓAl_{y}Ti_{z}(PO₄)₃, 0<x<2, 0<y<1, and 0<z<3), Li_{1+x+y}(Al, Ga)ₓ(Ti, Ge)₂₋ₓSi_{y}P_{3-y}O₁₂ (0≤x≤1 and 0≤y≤1), lithium lanthanum titanate (LiₓLa_{y}TiO₃, 0<x<2 and 0<y<3), lithium germanium thiophosphate (LixGeyPzSw, 0<x<4, 0<y<1, 0<z<1 and 0<w<5), lithium nitride (LiₓN_{y}, 0<x<4, and 0<y<2), SiS₂-based glass (LiₓSi_{y}S_{z}, 0≤x<3, 0<y<2, 0<z<4), P₂S₅-based glass (LiₓP_{y}S_{z}, 0≤x<3, 0<y<3, 0<z<7), Li₃ₓLa_{2/3-x}TiO₃ (0≤x≤⅙), Li₇La₃Zr₂O₁₂, Li_{1+y}Al_{y}Ti_{2-y}(PO₄)₃ (0<y<1), Li_{1+z}Al_{z}Ge_{2-z}(PO₄)₃ (0≤z≤1), Li₂O, LiF, LiOH, Li₂CO₃, LiAlO₂, Li₂O—Al₂O₃—SiO₂—P₂O₅—TiO₂—GeO₂-based ceramics, Li₁₀GeP₂S₁₂, Li_{3.25}Ge_{0.25}P_{0.75}S₄, Li₃PS₄, Li₆PS₅Br, Li₆PS₅Cl, Li₇PS₅, Li₆PS₅I, Li_{1.3} Al_{0.3}Ti_{1.7}(PO₄)₃, LiTi₂(PO₄)₃, LiGe₂(PO₄)₃, LiHf₂(PO₄)₃, LiZr₂(PO₄)₃, Li₂NH₂, Li₃(NH₂)₂I, LiBH₄, LiAH₄, LiNH₂, Li_{0.34}La_{0.51}TiO_{2.94}, LiSr₂Ti₂NbO₉, Li_{0.06}La_{0.66}Ti_{0.93}Al_{0.03}O₃, Li_{0.34}Nd_{0.55}TiO₃, Li₂CdCl₄, Li₂MgCl₄, Li₂ZnI₄, Li₂CdI₄, Li_{4.9}Ga_{0.5+b}La₃Zr_{1.7}W_{0.3}O₁₂ (0≤δ<1.6), Li_{4.9}Ga_{0.5+b}La₃Zr_{1.7}W_{0.3}O₁₂ (1.7≤δ≤2.5), Li_{5.39}Ga_{0.5+b}La₃Zr_{1.7}W_{0.3}O₁₂ (0≤δ≤1.11), lithium phosphorus sulfide (Li₃PS₄), lithium tin sulfide (Li₄SnS₄), lithium phosphorus sulfur chloride iodide (Li₆PS₅Cl_{0.9}I_{0.1}), lithium tin phosphorus sulfide (Li₁₀SnP₂S₁₂), Li₂S, Li₂S—P₂S₅, Li₂S—SiS₂, Li₂S—GeS₂, Li₂S—B₂S₅, and Li₂S—Al₂S₅.

11. The lithium metal anode structure of claim 1, wherein the inorganic layer further includes an organic binder.

12. The lithium metal anode structure of claim 11, wherein the inorganic layer has a form in which the inorganic nanoparticles are dispersed in a matrix consisting of the organic binder.

13. The lithium metal anode structure of claim 11, wherein the organic binder includes at least one selected from polyvinylidene fluoride, polyvinylidene fluoride-hexafluoropropylene, polyvinylidene chloride, polybenzimidazole, polyimide, polyvinyl acetate, polyacrylonitrile, polyurethane, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenylsulfide, polyamideimide, polyetherimide, polyethylenesulfone, polyamide, polyacetal, polyethylene oxide, polyethylene glycol diacrylate, polyethylene glycol monoacrylate, polyphenylene oxide, polybutylene terephthalate, ethylene propylene diene terpolymer (EPDM), sulfonated EPDM, styrene butadiene rubber, fluororubber, and copolymers thereof.

14. The lithium metal anode structure of claim 11, wherein an amount of the organic binder is 50 wt % to 99 wt %, with respect to a total weight of the inorganic nanoparticles and the organic binder.

15. The lithium metal anode structure of claim 1, wherein a thickness of the inorganic layer is 0.1 μm to 10 μm.

16. The lithium metal anode structure of claim 1, wherein the separator membrane further includes a polymer coating layer on the inorganic layer.

17. The lithium metal anode structure of claim 16, wherein the polymer coating layer includes at least one selected from polyvinylidene fluoride, polyvinylidene fluoride-hexafluoropropylene, polyvinylidene chloride, polybenzimidazole, polyimide, polyvinyl acetate, polyacrylonitrile, polyurethane, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenylsulfide, polyamideimide, polyetherimide, polyethylenesulfone, polyamide, polyacetal, polyethylene oxide, polyethylene glycol diacrylate, polyethylene glycol monoacrylate, polyphenylene oxide, polybutylene terephthalate, ethylene propylene diene terpolymer (EPDM), sulfonated EPDM, styrene butadiene rubber, fluororubber, and copolymers thereof.

18. The lithium metal anode structure of claim 1, wherein the porous substrate is a polyolefin substrate.

19. The lithium metal anode structure of claim 18, wherein the polyolefin substrate includes at least one copolymer selected from polyethylene, polypropylene, polybutylene, polypentene, polyhexene, polyoctene, ethylene, propylene, butene, pentene, 4-methylpentene, hexene, and octene, or a mixture or combination thereof.

20. The lithium metal anode structure of claim 1, wherein a thickness of the porous substrate is 1 μm to 50 μm.

21. An electrochemical device comprising:
a lithium metal anode structure according to claim 1.

22. The electrochemical device of claim 21, wherein the electrochemical device includes at least one selected from a battery, a storage battery, a supercapacitor, a fuel cell, a sensor, and an electrochromic device.

23. A lithium metal battery comprising:
a cathode; and an anode including the lithium metal anode structure according to claim 1.

24. A method of manufacturing a lithium metal anode structure, the method comprising:
binding a separator membrane onto at least one surface of a lithium metal anode by using a roll or a press, wherein the separator membrane includes a porous substrate and an inorganic layer coated on the porous substrate, the inorganic layer includes inorganic nanoparticles having an average particle diameter of 5 nm to 200 nm, and the inorganic layer is arranged between the porous substrate and the lithium metal anode according to claim 1.

25. The method of manufacturing the lithium metal anode structure of claim 24, wherein the binding is performed by hot rolling or cold rolling.

26. The method of manufacturing the lithium metal anode structure of claim 24, wherein the hot rolling is performed at 40° C. to 80° C., and the cold rolling is performed at 20° C. to 30° C., and the binding is performed at a nip pressure of 50 kgf to 1,000 kgf.
